(19) United States
(12) Patent Application Publication
(10) Pub. No.: US 2008/0077312 A1
(43) Pub. Date: Mar. 27, 2008

(54) System, Method, and Apparatus, for Mobile Radar Assisted Traffic Enforcement

(76) Inventor: Charles G. Mrotek, San Dimas, CA (US)

Correspondence Address: PATENT VENTURE GROUP, 10788 CIVIC CENTER DRIVE, SUITE 215, RANCHO CUCAMONGA, CA, 91730, US

(21) Appl. No.: 11/535,474

(22) Filed: Sep. 26, 2006

(51) Int. Cl. G08G 1/00

(52) U.S. Cl. 701/117

(57) ABSTRACT

An invention is provided for mobile radar assisted traffic enforcement. In one embodiment, a traffic control vehicle is disclosed that includes a driving station capable of providing directional and speed control for the traffic control vehicle. The traffic control vehicle also includes a positioning system device, such as a GPS device, a radar system, and a camera system. Further included within the traffic control vehicle is at least one traffic monitoring station having a monitoring client, such as a laptop computer, in communication with the positioning system device, the radar system, and the camera system. The monitoring client displays a visual image of the target vehicle, the current speed of the target vehicle, and the current location of the traffic control vehicle. In addition, the monitoring client is in communication with a storage device capable of storing a record of the image of the target vehicle, the current speed of the target vehicle, and the current location of the traffic control vehicle. In this manner, the record can be utilized to issue traffic citations.

### BACKGROUND OF THE INVENTION

1. Field of the Invention

This invention relates generally to radar assisted traffic law enforcement, and more particularly to mobile radar assisted traffic law enforcement having multiple-view evidence capture capability.

2. Description of the Related Art

Today, radar plays an important role in traffic safety enforcement. For example, one typical radar system currently utilized by law enforcement is a Doppler radar system. In a Doppler radar system, a microwave signal is transmitted at a particular frequency toward an object, reflected off the object, and received back at the Doppler radar system.

The velocity of the object has an affect on the transmitted frequency reflected back to the Doppler radar system. As such, the frequency received back at the Doppler radar system generally is different than the frequency transmitted. This shift in frequency is known as the “Doppler Effect,” and is proportional to the speed of the object. Hence, the Doppler radar system measures this shift in frequency to calculate the speed of the object.

For example, FIG. 1 is a diagram showing how a conventional Doppler radar system is utilized to measure traffic speeds for assistance in traffic law enforcement. FIG. 1 shows a vehicle 100 traveling along a highway 102. To observe traffic speeds, a police officer utilizing a Doppler radar system in the form of a radar gun 104 is positioned along the side of the highway 102.

During operation, the police officer points the radar gun 104 toward traffic traveling along the highway 102. The radar gun 104 transmits a microwave signal 106, which travels toward the vehicle 100. When the vehicle 100 travels into the transmitted microwave signal 106, the signal is reflected, and a reflected signal 108 is received back at the radar gun 104. As mentioned above, the reflected signal 108 has a different frequency than the frequency of the transmitted microwave signal 106 because of the speed of the vehicle 100.

The radar gun 104 then measures the shift in frequency and utilizes the measured frequency shift to calculate the speed of the vehicle 100. The officer can then utilize the radar gun 104 information in traffic enforcement. For example, if the speed of the vehicle 100 is calculated to be over the speed limit, the officer can pull over the vehicle 100 and issue a speeding ticket.

Unfortunately, most Doppler radar systems typically are operated from a stationary position as illustrated in FIG. 1. As a result, the officer is limited to the traffic along the selected highway for traffic enforcement. To monitor different traffic, the officer must move to a different stationary position and monitor traffic from the new location, ignoring traffic in the old location.

New radar systems allow the radar to be mounted in a moving vehicle, such as a police car. However, the radar requires the officer to both drive and monitor the radar display simultaneously. As a result, the officer may be distracted from driving safely, or be unable to adequately monitor the radar for traffic speed violations. Moreover, problems can occur when more than one vehicle is within the transmitted microwave signal of the radar system, as illustrated in FIG. 2.

FIG. 2 is a diagram showing a conventional Doppler radar system wherein multiple vehicles are present in the transmitted signal from the radar gun 104. As illustrated in FIG. 2, two vehicles 200 and 202 are traveling within the radar cone 204 of the radar gun 104. Here, the transmitted signal from the radar gun 104 will travel to all vehicles within the radar cone 204. However, the radar gun 104 will only display the speed of one of the vehicles 200 or 202. Thus, the difficulty is in the identification of which vehicle 200 or 202 is generating the speed displayed on the radar gun 104.

In particular, the radar gun 104 will display the speed of the “strongest” radar echo, that is, the strongest reflected signal. Typically, the strongest radar echo is caused by the closest vehicle to the radar gun 104, in this case vehicle 202. However, this is not always true. The reflected radar signal strength can be affected by the size, shape, and surfaces of the vehicles passing within the radar cone 204. Thus, when a plurality of vehicles pass within the radar cone 104 simultaneously, there can be situations wherein identification of which vehicle is producing the displayed speed can be difficult or impossible.

In view of the foregoing, there is a need for systems and methods for radar assisted traffic enforcement that are mobile and avoid indeterminate vehicle violation detection. The systems should provide safe and accurate vehicle and radar operation during mobile operation, and avoid multiple vehicles within the radar cone during operation. In addition, the systems should allow for accurate auditing of traffic violations for recording and evidentiary purposes.

### SUMMARY OF THE INVENTION

Broadly speaking, embodiments of the present invention provide mobile radar assisted traffic enforcement through the use of a vehicle capable of recording traffic violations. In one embodiment, a traffic control vehicle for mobile radar assisted traffic enforcement is disclosed. The traffic control vehicle includes a driving station capable of providing directional and speed control for the traffic control vehicle. The traffic control vehicle also includes a radar system, a camera system, and a positioning system device, such as a Global Positioning System (GPS) device and/or a Long Range Navigation (LORAN) device. Further included within the traffic control vehicle is at least one traffic monitoring station having a monitoring client, such as a laptop computer, in communication with the positioning system device, the radar system, and the camera system. The monitoring client displays a visual image of the target vehicle, the current speed of the target vehicle, and the current location of the traffic control vehicle. In addition, the monitoring client is in communication with a storage device capable of storing a record of the image of the target vehicle, the current speed of the target vehicle, and the current location of the traffic control vehicle. In this manner, the record can be utilized to issue traffic citations.

A system for mobile radar assisted traffic enforcement is disclosed in an additional embodiment of the present invention. The system includes a plurality of traffic control vehicles as described above. Further, a plurality of processing offices is included. Here, each traffic control vehicle transfers the stored record images to one of the processing offices upon completion of its shift of operation. Once the record images are transferred, each processing office is capable of processing record images for citation issuance. Each processing office can examine the record images and issue citations for fines based on the recorded speed of the target vehicle. Optionally, each processing office can examine the record images and issue citations for a flat fee fine.

In a further embodiment, a method for providing mobile radar assisted traffic enforcement is disclosed. The method includes operating a plurality of traffic control vehicles, as described above, along predetermined patrol routes. Upon completion of its patrol, each traffic control vehicle transfers stored record images to a processing office. Each processing office processes the stored record images to determine the owner of each target vehicle, and a citation is then issued to the owner of each target vehicle. Optionally, 1/12 traffic violation point can be assessed to the owner of the target vehicle. Advantageously, embodiments of the present invention give motorist a strong incentive to slow down and avoid traffic violations because of the fine, but allow motorist to keep their driver's license because of the reduced traffic violation points. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a diagram showing how a conventional Doppler radar system is utilized to measure traffic speeds for assistance in traffic law enforcement;

FIG. 2 is a diagram showing a conventional Doppler radar system wherein multiple vehicles are present in the transmitted signal from the radar gun;

FIG. 3 is a diagram showing an exemplary traffic control vehicle, in accordance with an embodiment of the present invention;

FIG. 4 is a diagram showing an exemplary traffic monitoring station in communication with a traffic detection system, in accordance with an embodiment of the present invention;

FIG. 5 is illustration showing an exemplary monitoring client screen layout for use with a monitoring client, in accordance with an embodiment of the present invention;

FIG. 6 is an illustration showing a traffic control vehicle during normal operation, in accordance with an embodiment of the present invention; and

FIG. 7 is a flowchart showing a method for providing mobile radar assisted traffic enforcement, in accordance with an embodiment of the present invention.

### DETAILED DESCRIPTION OF THE PREFERRED EMBODIMENTS

An invention is disclosed for a mobile radar traffic enforcement system having audit trail capability. Embodiments of the present invention provide a traffic control system comprising a traffic control vehicle having a plurality of strategically placed radar systems and corresponding camera systems for audit purposes. In general, a driving station is utilized to operate the direction and velocity of the vehicle, while a separate traffic monitoring station is utilized to operate and monitor the radar and camera systems. Additional traffic monitoring stations can be included to increase traffic monitoring accuracy. Advantageously, embodiments of the present invention allow the safe operation of the traffic control vehicle, while the separate traffic monitoring stations allow the accurate monitoring of traffic. Moreover, because the traffic control vehicle can be utilized in close proximity to the monitored traffic, multiple vehicles in the radar cones can be avoided.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

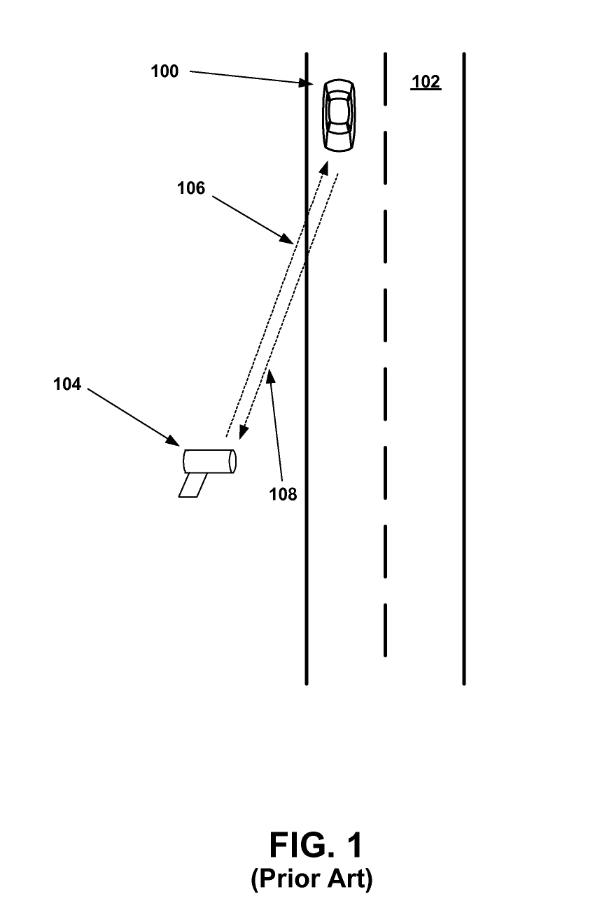

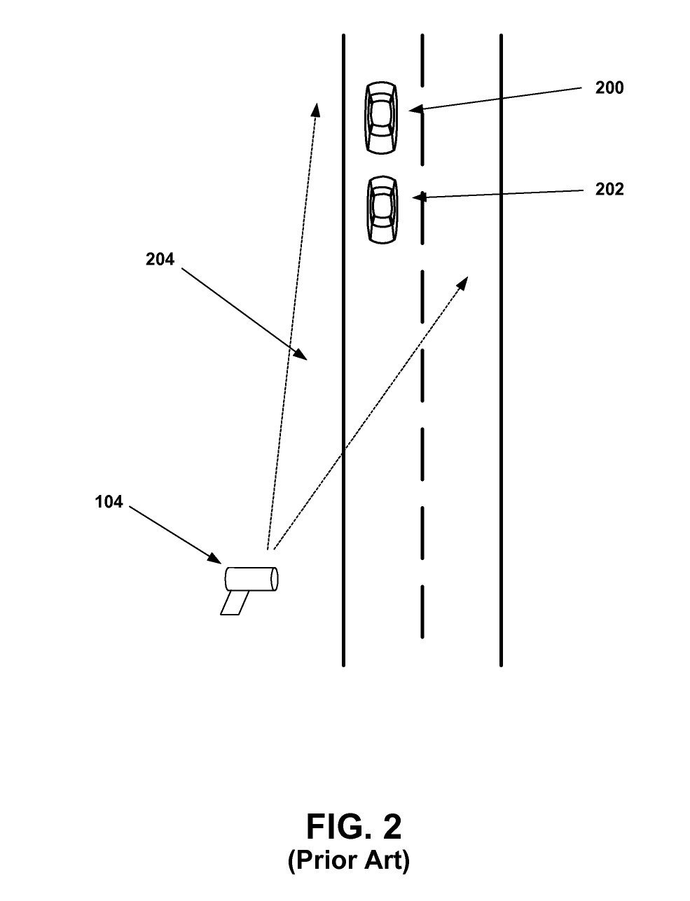

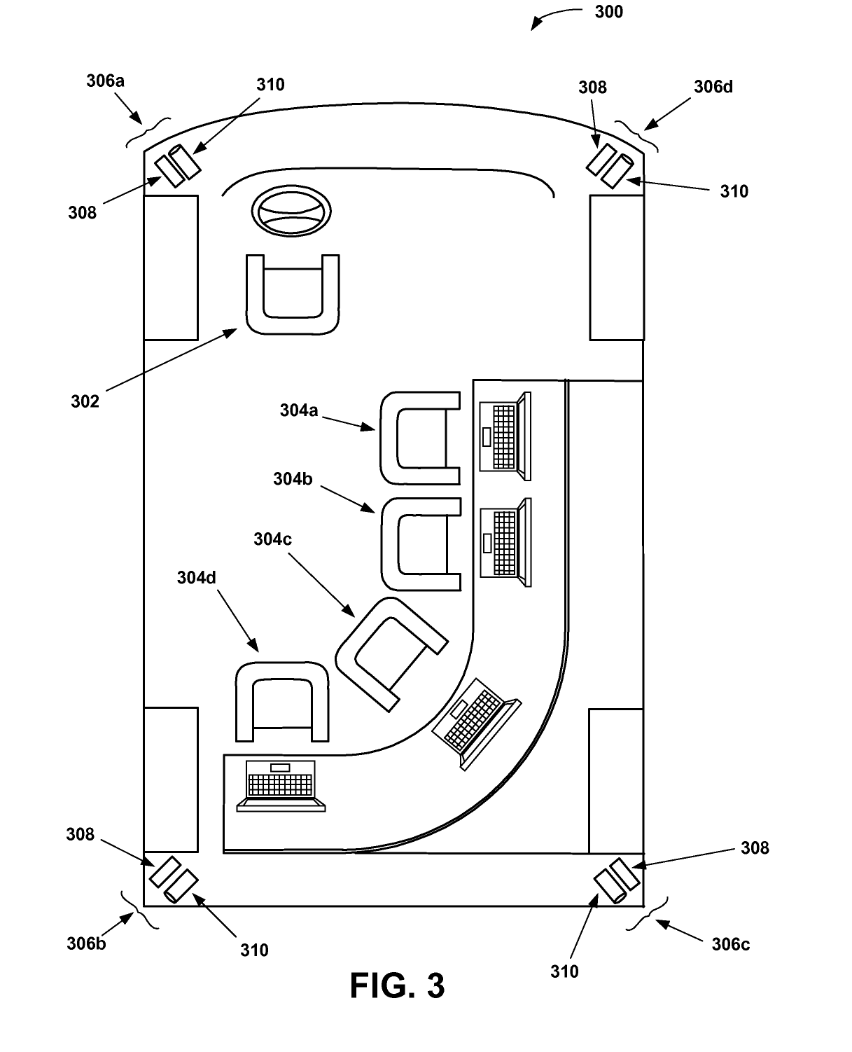

FIGS. 1 and 2 have described in terms of the prior art. FIG. 3 is a diagram showing an exemplary traffic control vehicle 300, in accordance with an embodiment of the present invention. The traffic control vehicle 300 includes a driving station 302 and a plurality of traffic monitoring stations 304a-304d. In communication with each traffic monitoring station 304a-304d is a corresponding traffic detecting system 306a-306d, each including a radar system 308 and a camera system 310.

In operation, a driver utilizes the driving station 302 to operate the direction and velocity of the traffic control vehicle 300. The traffic control vehicle 300 can utilize the basic body and engine structure of any vehicle available. For example, in one embodiment the traffic control vehicle can utilize a van body and engine structure to allow for additional traffic control operators as described subsequently. However, it should be noted that any body and engine structure can be utilized for the traffic control vehicle, such as a sport-utility vehicle (SUV), truck, sedan, or any other vehicle body as will be apparent to those skilled in the art after a careful reading of the present disclosure.

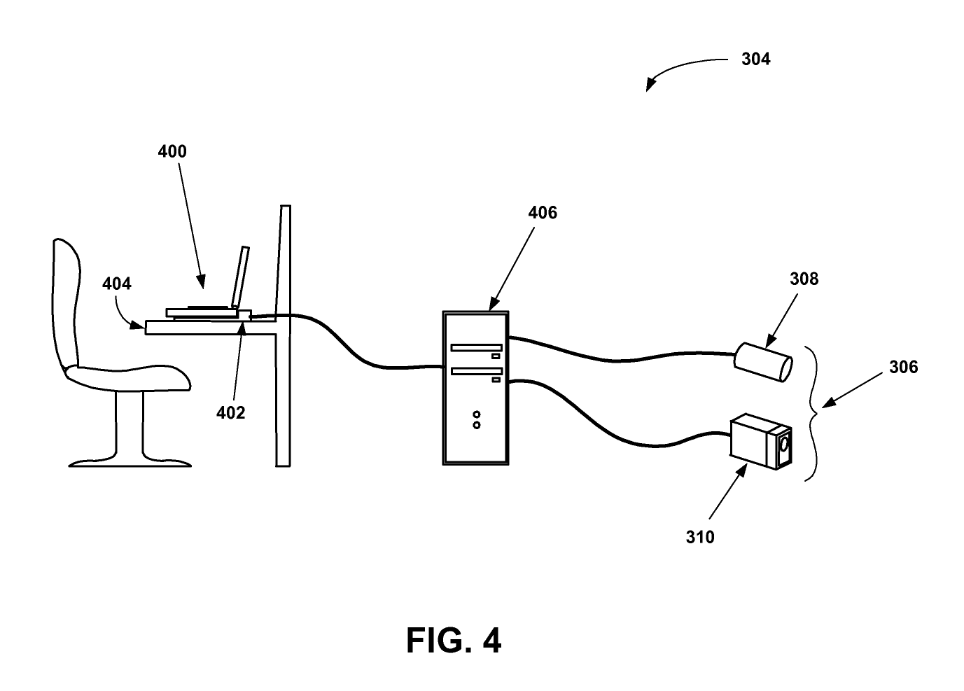

The traffic monitoring stations 304a-304c are utilized to monitor traffic surrounding the traffic control vehicle 300. Although the exemplary traffic control vehicle of FIG. 3 is shown with four traffic monitoring stations 304a-304c, in should be borne in mind that the exemplary traffic control vehicle 300 can include any number of traffic monitoring stations 304a-304c. For example, a traffic control vehicle can include less than four traffic monitoring stations 304, with each traffic monitoring station 304 in communication with multiple traffic detection systems 306. In another embodiment, the traffic control vehicle can have more than four traffic monitoring stations, with traffic monitoring stations 304 sharing traffic monitoring detection systems 306. In addition, it should be noted that any number of traffic detection systems 306 can be included in the traffic control vehicle 300. To perform this monitoring function, each traffic monitoring station 304a-304c is in communication with at least one traffic detection system 306a-306d, as described next with reference to FIG. 4.

FIG. 4 is a diagram showing an exemplary traffic monitoring station 304 in communication with a traffic detection system 306, in accordance with an embodiment of the present invention. The exemplary traffic monitoring station 304 includes a monitoring client 400 for monitoring data from the traffic detection system 306. The monitoring client 400 can be any system designed for monitoring data from the traffic detection system 306. For example, the monitoring client 400 can be a laptop computer, desktop computer, terminal, closed circuit television (CCTV) monitor, or any other system designed for monitoring data from the detection system 306.

In the example of FIG. 4, the monitoring client 400 is a laptop computer coupled to a docking bay 402, which is secured to desk 404. The monitoring client 400 is in communication with a server computer 406, which is further in communication with a radar system 308 and corresponding camera system 310. It should be noted that in some embodiments the server computer system 406 can be omitted. In which case, the radar system 308 and camera system 310 can be in direct communication with the monitoring client 400.

In operation, the radar system 308 detects the speeds of vehicles within its field of view. That is, the radar system 308 transmits a microwave signal that travels toward a target vehicle within its field of view. The signal is then reflected from the target vehicle and the reflected signal is received back at the radar system 308. The reflected signal has a different frequency than the frequency of the transmitted microwave signal because of the speed of the target vehicle.

The radar system 308 then measures the shift in frequency and utilizes the measured frequency shift to calculate the speed of the target vehicle. The speed information is then provided to the monitoring client 400 via the server computer 406. It should be noted that the radar system 108 can transmit the transmit frequency information, reflected signal frequency information, and/or the Doppler shift information to the monitoring client 400 and/or the server computer 406. In this case, the speed of the target vehicle can be calculated utilizing the monitoring client 400 and/or the server computer 406.

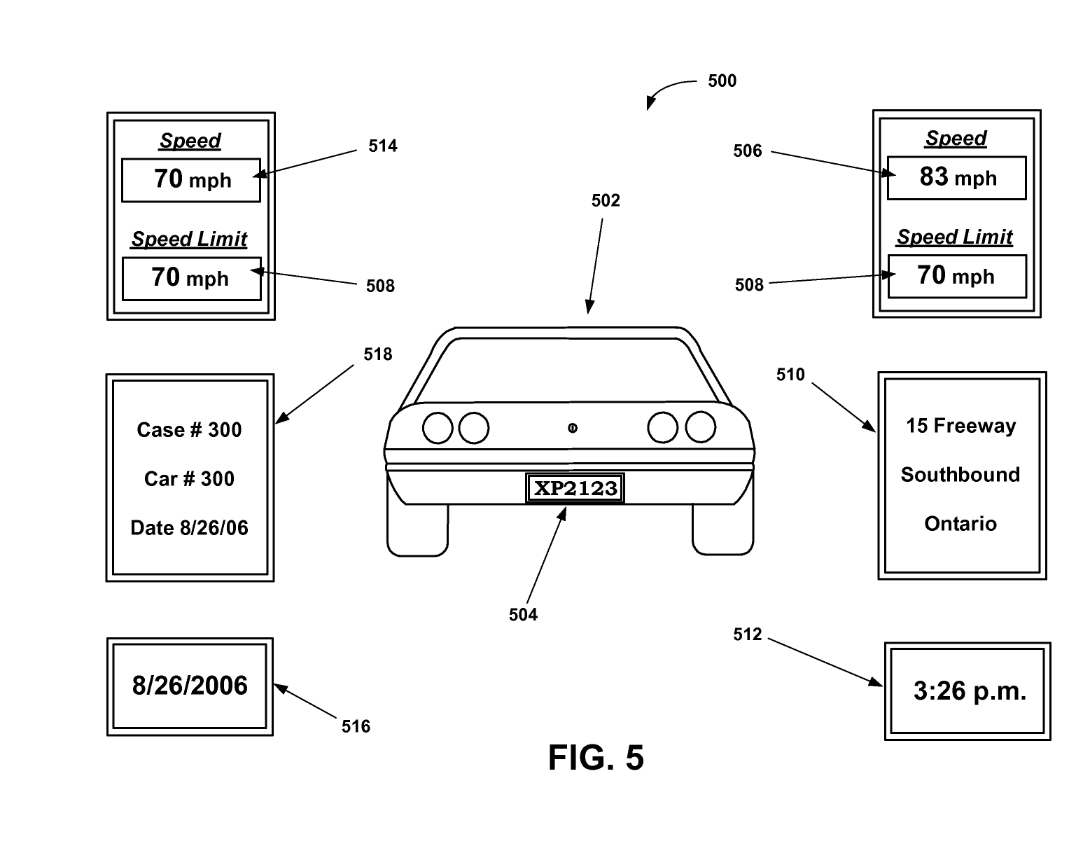

While the radar system 308 is gathering speed data for the target vehicle, the camera system 310 gathers visual data for the target vehicle. Specifically, the camera system 310 has a field of view that effectively coincides with the field of view of the radar system 308. In this manner, the camera system 310 can gather visual data, such as license plate information and driver identity information, for the target vehicle. As with the speed information, the visual data is provided to the monitoring client 400 via the server computer 406. Consequently, a user at traffic monitoring station 304 can monitor outside traffic via the monitoring client 400, as described next with reference to FIG. 5.

FIG. 5 is illustration showing an exemplary monitoring client screen layout 500 for use with a monitoring client 400, in accordance with an embodiment of the present invention. The monitoring client screen layout 500 includes an image of the target vehicle 502, including the license plate 504 of the target vehicle 502. In addition, the right side of the monitoring client screen layout 500 includes data regarding the target vehicle, while the left side of the monitoring client screen layout 500 includes data regarding the traffic control vehicle.

In particular, the right side of the monitoring client screen layout 500 includes the current speed 506 of the target vehicle 502 and the legal speed limit 508 for the current location. Positioning system equipment and software, such as Global Positioning System (GPS) and/or Long Range Navigation (LORAN) equipment and software, can be included in the traffic control vehicle 300 to provide current location information. As such, the current location 510 of the traffic control vehicle can be displayed, along with the current time of day 512. The left side of the monitoring client screen layout 500 includes the current speed 514 of the traffic control vehicle 300, the legal speed limit 508 for the current location, and the current date 516.

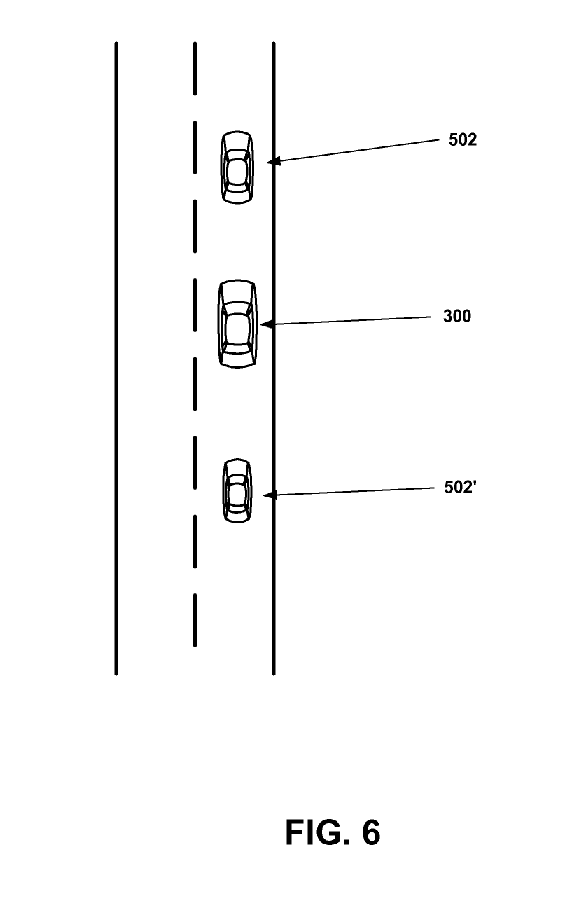

In addition, case information 518 is displayed. The case information 518 can include, for example, the current case number, the total number of vehicles monitored thus far, and the date, as will be described in greater detail subsequently. The information displayed on the monitoring client screen layout 500 is recorded and utilized to document and prosecute traffic violations, as described next with reference to FIG. 6.

FIG. 6 is an illustration showing a traffic control vehicle 300 during normal operation, in accordance with an embodiment of the present invention. As shown in FIG. 6, during normal operation the traffic control vehicle 300 travels along freeways, highways, and other roads to monitor traffic. For example, an operator utilizing a traffic monitoring station 304a within the traffic control vehicle 300 can monitor a target vehicle 502, while a driver at the driving station 302 drives the traffic control vehicle 300. Since multiple traffic monitoring stations 304a-304b can be included in the traffic control vehicle 300, another operator utilizing a second traffic monitoring station 304b can simultaneously monitor a second target vehicle 502′. Additional operators at additional traffic monitoring stations 304c-304d can simultaneously monitor further target vehicles.

As described above with reference to FIG. 4, the radar systems 308 gather speed data for the target vehicles 502 and 502′, and the camera systems 310 gather visual data for the target vehicles 502 and 502′, such as license plate information and driver identity information. Both the speed data and the visual data are provided to the monitoring client 400 of the respective traffic monitoring station 304.

For example, while a driver drives the traffic control vehicle 300, an operator at traffic monitoring station 304a can monitor target vehicle 502. As shown in FIG. 5, the monitoring client displays the monitoring client screen layout 500, which the operator uses to evaluate target vehicle 502. The current speed 506 of the target vehicle 502 and the legal speed limit 508 for the current location can be utilized to determine whether the target vehicle is in violation of the current traffic laws.

When an operator determines a target vehicle is in violation of current traffic laws, the operator can utilize the monitoring client to record the violation. In response, the monitoring client functions to save a record image of the monitoring client screen layout 500. The record image can be saved locally at the monitoring client 400, on the server computer 406, or in any other manner capable of saving a copy of the record image. Optionally, a digital fingerprint can be included, such as a watermark, to ensure authenticity of the record image. In this manner, the record image can be certified for evidence purposes.

As a result, the record image includes an image of the target vehicle 502, generally including the license plate 504, the current speed 506 of the target vehicle 502 and the current legal speed limit 508. In addition, the record image includes the current location 510 where the image was captured, along with the current time of day 512. Also, the current speed 514 of the traffic control vehicle 300, the legal speed limit 508, and the current date 516 are included in the record image.

To assist in citation processing, case information 518 is included. As mentioned above, the case information 518 can include, for example, the current case number, the total number of vehicles monitored thus far, and the date. In one embodiment, the record image is saved to a non-rewriteable media, such as a non-rewriteable CD, to avoid possible image tampering. In this manner, the record images of traffic violations can be utilized to issue traffic citations, which are later mailed to the violator and/or owner of the violating target vehicles.

In one embodiment, a plurality of traffic control vehicles 300 can be operated throughout the county, state, or country simultaneously. Each traffic control vehicle 300 operates to capture record images of traffic violators throughout the day. At the end of each day of operation, the record images stored within each traffic control vehicle 300 can be transferred to an office for processing. During processing, each record image is examined to determine the owner of the violating target vehicle 502, generally via the license plate image 504. The speed data 506 and speed limit data 508 can be utilized to determine the extent of the fine, and a citation can be issued and sent to the owner of the target vehicle.

In one embodiment, the fine for each citation can be reduced because an actual police officer has not issued the citation. That is, the formality involved in normal traffic stops, wherein a police officer pulls over the violating vehicle and issues the operator a traffic citation, is not used. In addition, in states such as California wherein traffic violation points are assessed for traffic violations, the number of points assessed for each violation can be reduced. For example, in one embodiment, fines for each issued citation can be set at $100.00 and 1/12 traffic violation point can be assessed for each issued citation.

In this manner, embodiments of the present invention can be utilized to reduce traffic violations. Advantageously, embodiments of the present invention give motorist a strong incentive to slow down and avoid traffic violations because of the fine, but allow motorist to keep their driver's license because of the reduced traffic violation points. That is, generally only motorist who repeatedly violate traffic laws within the monitoring range of traffic control vehicles 300 can possibly lose their driver's license because of these vehicles.

In some embodiments, a single private company can operate a plurality of traffic control vehicles 300. For example, a single company can operate a plurality of offices throughout a state, with, for example, three hundred traffic control vehicles 300 operating twenty-four hours each day. In this embodiment, employees of the company can be required to have a security license and background check. In addition, each employee can be cross-trained to do a plurality of jobs associated with operation of the traffic control vehicles 300.

It is estimated that a single traffic control vehicle 300 can record between 1000 and 5000 violating vehicles in an 8-hour period. When using a basic fine of $100.00 per violation, each traffic control vehicle 300 can generate between $100,000.00 to $500,000.00 in fines per eight hours of operation. When operated 24 hours per day, that is three eight-hour shifts per day, each traffic control vehicle 300 can generate between $300,000.00 to $1,500,000.00 in fines per day. Thus, three hundred traffic control vehicles operated 24 hours each day can generate a large amount of revenue for county and/or state.

In one embodiment, each office operated by the company can issue its own citations. In this case, the state Department of Motor Vehicles (DMV) can operate an office in each company office. For added security, each such operated DMV office can be sealed to DMV personal only. The DMV office can also be utilized to receive monies for fine payment. That is, the DMV office can include and accounting office to process paid fines and perform banking for company and the county and/or state. In this manner, the state can have state employed personal present to ensure proper processing. In a similar manner, state officials and highway patrol officers can be stationed at each office for additional monitoring of proper procedure in company offices.

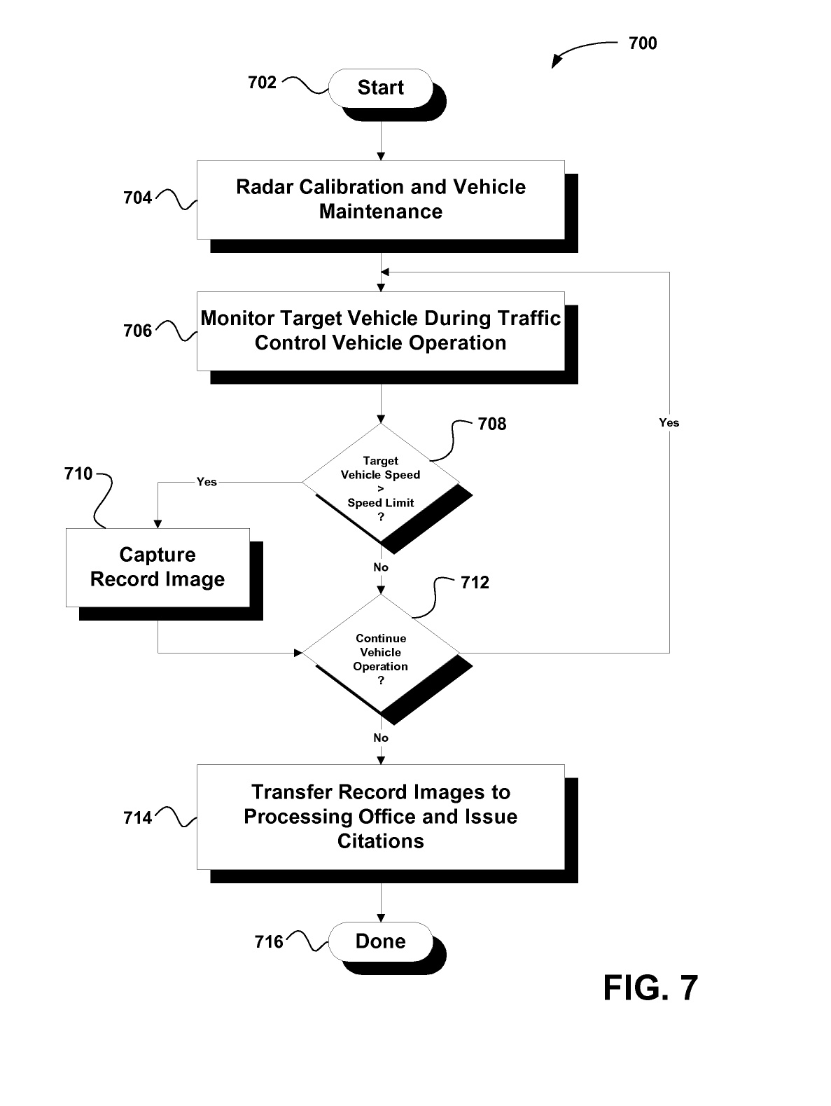

FIG. 7 is a flowchart showing a method 700 for providing mobile radar assisted traffic enforcement, in accordance with an embodiment of the present invention. In an initial operation 702, preprocess operations are performed. Preprocess operations can include, for example, processing office setup, government official placement, patrol route selection, and other preprocess operations as will be apparent to those skilled in the art after a careful reading of the present disclosure.

In operation 704, radar calibration and vehicle maintenance is performed. In general, each traffic control vehicle 300 is maintained in proper operating order via periodic vehicle inspection and maintenance. In addition, each radar system 308 maintained on the traffic control vehicle preferable is calibrated each day prior to vehicle operation. In one embodiment, radar system 300 calibration can be performed prior to each 8-hour vehicle operation shift. In this manner, citation errors can be avoided. In addition, each radar calibration should be properly documented for evidentiary purposes. Once proper maintenance and radar calibration has been performed, the traffic control vehicle is ready for operation.

During operation of the traffic control vehicle, target vehicles are monitored, in operation 706. During this operation, a driver drives the traffic control vehicle along a selected patrol route. At the same time, operators at each traffic monitoring station 304a-304d monitor target vehicles. To this end, the radar systems of the traffic control vehicle gather speed data for the target vehicles, and the camera systems of the traffic control vehicle gather visual data for the target vehicles. Both the speed data and the visual data are provided to the monitoring client of the respective traffic monitoring station.

A decision is then made as to whether the target vehicle speed is greater than the current speed limit, in operation 708. If the target vehicle speed is greater than the current speed limit, the method 700 branches to capture operation 710. Otherwise, the method 700 continues to operation 712.

In capture operation 710, a record image of the target vehicle is captured. When an operator determines a target vehicle is in violation of current traffic laws, the operator can utilize the monitoring client to record the violation. In response, the monitoring client functions to save a record image of the monitoring client screen layout. As mentioned above, the record image can be saved locally at the monitoring client, on the server computer, or in any other manner capable of saving a copy of the record image. Optionally, a digital fingerprint can be included, such as a watermark, to ensure authenticity of the record image. In this manner, the record image can be certified for evidence purposes.

In operation 712 a decision is made as to whether vehicle operation should continue. As discussed previously, the traffic control vehicle is operated for a particular number of hours each day before operation ceases for the day or shift. If the vehicle operation should continue, the method 700 branches to another monitoring operation 706. Otherwise, the method 700 continues to transfer operation 714.

In transfer operation 714, the record images recorded during the current operation shift are transferred to a processing office and appropriate citations are issued. At the end of each day or shift of operation, the record images stored within the traffic control vehicle are transferred to a processing office for processing. In one embodiment, the record image is saved to a non-rewriteable media, such as a non-rewriteable CD, to avoid possible image tampering. During processing, each record image is examined to determine the owner of the violating target vehicle, generally via the license plate in the image. The speed data and speed limit data can be utilized to determine the extent of the fine. To assist in citation processing, case information is included in the record image. As mentioned above, the case information can include, for example, the current case number, the total number of vehicles monitored thus far, and the date. In this manner, the record images of traffic violations can be utilized to issue traffic citations, which are later mailed to the violator and/or owner of the violating target vehicles.

Post process operations are then performed in operation 716. Post process operations can include, for example, receiving payment for fines, vehicle crew debriefing, and other post process operations that will be apparent to those skilled in the art after a careful reading of the present disclosure. Advantageously, embodiments of the present invention allow the safe operation of the traffic control vehicle, while the separate traffic monitoring stations allow the accurate monitoring of traffic. Moreover, embodiments of the present invention give motorist a strong incentive to slow down and avoid traffic violations because of the fine, but allow motorist to keep their driver's license because of the reduced traffic violation points.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A traffic control vehicle for mobile radar assisted traffic enforcement, comprising:
a driving station capable of providing directional and speed control for the traffic control vehicle;
a positioning system device capable of determining a current location of the traffic control vehicle;
a radar system capable of obtaining speed data for a target vehicle;
a camera system capable of obtaining visual data for the target vehicle; and
a traffic monitoring station having a monitoring client in communication with the positioning system device, the radar system, and the camera system, wherein the monitoring client displays a visual image of the target vehicle, a current speed of the target vehicle, and the current location of the traffic control vehicle, the monitoring client further in communication with a storage device capable of storing a record of the image of the target vehicle, the current speed of the target vehicle, and the current location of the traffic control vehicle.

2. A traffic control vehicle as recited in claim 1, wherein the driving station is operated by a first operator and the traffic monitoring station is operated by a second operator.

3. A traffic control vehicle as recited in claim 1, further comprising at least two traffic monitoring stations, each operated by a separate operator.

4. A traffic control vehicle as recited in claim 3, further comprising at least two radar systems and at least two camera systems, wherein each traffic monitoring station is in communication with one radar system and one camera system.

5. A traffic control vehicle as recited in claim 1, further comprising a server computer in communication with the traffic monitoring station, the server computer being in further communication with the radar system and the camera system.

6. A traffic control vehicle as recited in claim 1, wherein a digital fingerprint is included within the record of the image of the target vehicle.

7. A traffic control vehicle as recited in claim 1, wherein the positioning system device is a Global Positioning System (GPS) device.

8. A traffic control vehicle as recited in claim 1, wherein the positioning system device is a Long Range Navigation (LORAN) device.

9. A system for mobile radar assisted traffic enforcement, comprising:
a plurality of traffic control vehicles, wherein each traffic control vehicle comprises:
a driving station capable of providing directional and speed control for the traffic control vehicle;
a positioning system device capable of determining a current location of the traffic control vehicle;
a radar system capable of obtaining speed data for a target vehicle;
a camera system capable of obtaining visual data for the target vehicle; and
a traffic monitoring station having a monitoring client in communication with the positioning system device, the radar system, and the camera system, wherein the monitoring client displays a visual image of the target vehicle, a current speed of the target vehicle, and the current location of the traffic control vehicle, the monitoring client further in communication with a storage device capable of storing a record image including an image of the target vehicle, the current speed of the target vehicle, and the current location of the traffic control vehicle; and
a plurality of processing offices, wherein each traffic control vehicle transfers stored record images to a processing office of the plurality of processing offices, and wherein each processing office of the plurality of processing offices is capable of processing record images for citation issuance.

10. A system as recited in claim 9, wherein each processing office examines record images and issues citations for fines based on the recorded speed of the target vehicle.

11. A system as recited in claim 9, wherein each processing office examines record images and issues citations for a flat fee fine.

12. A system as recited in claim 9, wherein each traffic control vehicle further comprises at least two traffic monitoring stations, each operated by a separate operator.

13. A system as recited in claim 12, wherein each traffic control vehicle further comprises at least two radar systems and at least two camera systems, wherein each traffic monitoring station is in communication with one radar system and one camera system.

14. A system as recited in claim 9, wherein the positioning system device is a Global Positioning System (GPS) device.

15. A traffic control vehicle as recited in claim 9, wherein the positioning system device is a Long Range Navigation (LORAN) device.

16. A method for providing mobile radar assisted traffic enforcement, comprising the operations of:
operating a plurality of traffic control vehicles along predetermined patrol routes, wherein each traffic control vehicle comprises:
a driving station capable of providing directional and speed control for the traffic control vehicle;
a positioning system device capable of determining a current location of the traffic control vehicle;
a radar system capable of obtaining speed data for a target vehicle;
a camera system capable of obtaining visual data for the target vehicle; and
a traffic monitoring station having a monitoring client in communication with the positioning system device, the radar system, and the camera system, wherein the monitoring client displays a visual image of the target vehicle, a current speed of the target vehicle, and the current location of the traffic control vehicle, the monitoring client further in communication with a storage device capable of storing a record image including an image of the target vehicle, the current speed of the target vehicle, and the current location of the traffic control vehicle;
transferring stored record images from each traffic control vehicle to a processing office;
processing the stored record images at each processing office to determine an owner of each target vehicle; and
issuing a citation to the owner of each target vehicle.

17. A method as recited in claim 16, wherein citations are issued for fines based on the recorded speed of the target vehicle.

18. A method as recited in claim 16, wherein citations are issued for a flat fine fee.

19. A method as recited in claim 16, further comprising the operation of assessing 1/12 traffic violation point to the owner of the target vehicle.

20. A method as recited in claim 16, wherein the positioning system device is a Global Positioning System (GPS) device.
